(19) United States
(12) Patent Application Publication
(10) Pub. No.: US 2023/0132546 A1
(43) Pub. Date: May 4, 2023

(54) SYSTEM AND METHOD FOR 3D PRINTING POROUS ZINC STRUCTURES

(71) Applicant: LAWRENCE LIVERMORE NATIONAL SECURITY, LLC, Livermore, CA (US)

(72) Inventors: Cheng Zhu, Livermore, CA (US); Eric B. Duoss, Dublin, CA (US); Zhen Qi, Tracy, CA (US); Tony W. Van Buuren, Livermore, CA (US); Marcus A. Worsley, Hayward, CA (US)

(21) Appl. No.: 17/453,396

(22) Filed: Nov. 3, 2021

(51) Int. Cl. B22F 10/18; B22F 10/80; B22F 3/11; B33Y 10/00; B33Y 30/00; H01M 4/04; H01M 4/134; B33Y 80/00; B33Y 50/00

(52) U.S. Cl. CPC B22F 10/18; B22F 10/80; B22F 3/114; B33Y 10/00; B33Y 30/00; H01M 4/0402; H01M 4/134; B33Y 80/00; B33Y 50/00; B22F 2301/30; H01M 2004/027

(57) ABSTRACT

Freeform fabrication of architected porous zinc via 3D printing. Ink including zinc powders, solvents and binders is created with printability. At least one 3D model is created with microarchitectures. Extrusion-based direct-writing is used to manufacture free-standing 3D zinc structures. Post-processing conditions generate final architected porous zinc products.

### STATEMENT AS TO RIGHTS TO APPLICATIONS MADE UNDER FEDERALLY SPONSORED RESEARCH AND DEVELOPMENT

This invention was made with Government support under Contract No. DE-AC52-07NA27344 awarded by the United States Department of Energy. The Government has certain rights in the invention.

### BACKGROUND

### Field of Endeavor

The present disclosure relates to 3D printing and more particularly to systems and methods for 3D printing porous zinc structures.

### State of Technology

This section provides background information related to the present disclosure which is not necessarily prior art.

Zinc is an earth-abundant metal that has been used as a potential “beyond lithium” material for its high theoretical capacity, low redox potential, and good water compatibility. Therefore, it can be directly used as cheap anode for its high reversibility in aqueous zinc-based batteries. However, detrimental dendrites, corrosion, and hydrogen evolution are main issues causing the anode degradation during cycling. Especially, the dead zinc from falling dendrites exacerbates localized uneven electric field and ions migration inducing even worse side reactions. Therefore, dendrite-free zinc anodes have become the prerequisite for the long-life batteries.

Conventional Zn foils or plates always suffer from quick passivation without full utilization of excess active materials leading to a low energy density. Several 3D current collectors have been created to support Zn, such as carbons (i.e., graphene foam, carbon nanotube networks), and metals (i.e., nickel foam, porous copper, steel mesh). However, these scaffolds add extra weight and have interfacial affinity problems with deposited zinc. Recently, 3D pure Zn anodes including wires, sponges, foams, nanosheets, and nanoporous monoliths and alloys have also been developed, whereas their randomly porous structures impedes the mass transfer of electrolyte and considerably increases the ion transfer distance.

Additive manufacturing is a category of freeform fabrication techniques that build 3D structures by sequentially layering one material on top of another in a desired pattern. The direct ink writing is one of extrusion-based additive manufacturing methods that employ a computer-controlled translation stage to deposit customized “inks” through a print head into programmed designs. The patterns are generated by stacking 2D layers consisting of simple, one-dimensional filaments to complex, 3D structures. The inks are administered through micro-nozzles, and filament diameter is determined by nozzle size, print speed, and rates of ink flow and solidification. Here, we develop a new colloidal-based zinc ink to print self-supported 3D anodes with designed internal structure show greater degree of freedom to regulate the electron transfer kinetics, ion flux, and nucleation barrier and sites.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant's apparatus, systems, and methods provide freeform fabrication of architected porous zinc via 3D printing. Ink including zinc powders, solvents and binders is created with printability. At least one 3D model is created with microarchitectures. Extrusion-based direct-writing is used to manufacture free-standing 3D zinc structures. Post-processing conditions generate final architected porous zinc products.

In one aspect the present disclosure relates to a method of forming 3D zinc structures. In one embodiment, an ink includes a copolymer binder, a zinc powder, and an organic volatile solvent system. The method may involve providing a zinc micro-powder and mixing the powder with an organic binder and solvents system to form a shear-reversible ink. In another embodiment, a method includes printing a 3D structure using an ink, drying and annealing the printed structure. A 3D printing technique may be used to write the ink into versatile shapes and structures. The 3D printing may be performed to apply the ink to form a plurality of ink layers, one on top of another, to form a wet three dimensional part having a desired shape and desired dimensions. The ink may be used to form a wet part with minimal collapsing due to its instant shape retention by controllable solvents evaporation. The wet part may then be dried in the air to form a freestanding green part. The dried part may then be annealed to form a finished zinc part in controlled atmosphere, temperature, and time.

In another aspect the present disclosure relates to a system for forming a porous zinc. The system may include a controller and a deposition component controlled by the controller for depositing an ink. The controller may be further configured to implement a 3D printing technique to write the ink at the corresponding speed of solvents evaporation rate. The 3D printing technique may be used by the controller to form a plurality of ink layers one on top of another to forma wet three dimensional part. In yet another embodiment, a product includes a 3D printed structure having ligaments, where an average diameter of the ligaments is in a range of about 200 microns, and pores size of about 500 microns. A surface treated substrate may be used for delaminating the wet part after drying. A subsystem may be included for annealing the dried part to form a finished part.

These printed zinc structures have large surface area and tailored porosity to facilitate the electrons and ions transport and even electric field and ion distribution as potential electrodes for high performance zinc-ion supercapacitors or batteries. Further areas of applicability will become apparent from the description provided herein. It should be understood that the description and specific examples are intended for purposes of illustration only and are not intended to limit the Scope of the present disclosure.

Other aspects and advantages of the present invention will become apparent from the following detailed description, which, when taken in conjunction with the drawings, illustrate by way of example the principles of the invention.

The system for forming a porous zinc of the present disclosure has use in a wide range of technologies, such as catalysis, desalination, energy storage, and filtration. The system for forming a porous zinc of the present disclosure has use in energy storage and particularly for Li-ion batteries.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The present disclosure relates to 3D printing and more particularly to systems and methods for 3D printing porous zinc structures.

The accompanying drawings, which are incorporated into and constitute a part of the specification, illustrate specific embodiments of the apparatus, systems, and methods and, together with the general description given above, and the detailed description of the specific embodiments, serves to explain the principles of the apparatus, systems, and methods.

FIG. 1 is a flowchart that illustrates one embodiment of the inventor's apparatus, systems, and methods for producing hierarchical zinc structures.

FIG. 2 is a flow diagram that illustrates the steps of zinc-based colloidal inks preparation.

FIG. 3 illustrates one embodiment of the 3D model of the inventor's microlattice anode.

FIG. 4 is an illustrative flow diagram that depicts the steps of the inventor's direct ink writing apparatus, systems, and methods for producing zinc microlattice.

FIG. 5 shows a series of optical images illustrating various shapes and structures of 3D-printed zinc.

FIG. 6 is a series of optical images and scanning electron microscope images illustrate the structure and morphology of a hierarchically porous zinc lattice after post-processing.

FIG. 7 is a flowchart that illustrates another embodiment of the inventor's apparatus, systems, and methods for producing hierarchical zinc structures.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified. As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc. The nanoscale is defined as between 1 nanometer and about 500 nanometers. For the purposes of this description, macropores are defined as having an average diameter of greater than 1 millimeter (mm). Mesopores are defined as having an average diameter of less than 1 mm and greater than about 10 microns (um). Micropores are defined as having an average diameter less than about 10 um and greater than about 100 nanometers (nm). Nanopores are defined as having an average diameter less than 1 um and greater than 0 nanometers. These ranges are approximate and may overlap, e.g., a large nanopore may also be defined as a small micropore.

A list of acronyms used in the description is provided below.

3D Three-dimensional

° C. Celsius

cm centimeter

DIW Direct ink writing

um micron

mg milligram

mm millimeter

nm nanometer

SEM Scanning electron microscope

The present invention uses an additive manufacturing operation, in one example a DIW additive manufacturing process, to fabricate hierarchical porous zinc with deterministically controlled, application specific, 3D architectures. Arbitrary macroscopic architectures and sample shapes can be printed according to the application requirements. Moreover, the structure of distinct levels of porosity can be tuned independently which enables application specific multiscale architectures of virtually any geometric 3D shape. The following description discloses several preferred embodiments of hierarchically porous zinc foams and/or related additive manufacturing systems, methods, and products formed by the same.

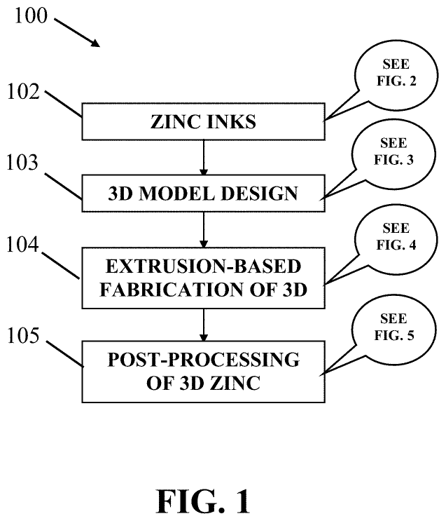

Referring now to FIG. 1, a flow chart illustrates one embodiment of the inventor's apparatus, systems, and methods for producing 3D zinc structures. The flow charter is designated generally by the reference numeral 100. As illustrated in the flow charter 100, the system includes a number of steps. The steps in FIG. 1 are identified and described below.

Step 1—ZINC INKS DEVELOPMENT (Reference numeral 102)—In step 1, a zinc powder based extrudable ink is developed.

Step 2-3D MODEL DESIGN (Reference numeral 103)—In step 2, the 3D geometrical models are designed using computer aided design (CAD) software or other systems for creating a digital model.

Step 3—EXTRUSION-BASED FABRICATION OF 3D ZINC (Reference numeral 104)—In step 3, the direct ink writing is employed to extrude developed inks into designed structures following the model from Step 2.

Step 4—POST-PROCESSING OF 3D ZINC STRUCTURES (Reference numeral 105)—In step 4, the as-printed green bodies are processed by drying and annealing to obtain the final products.

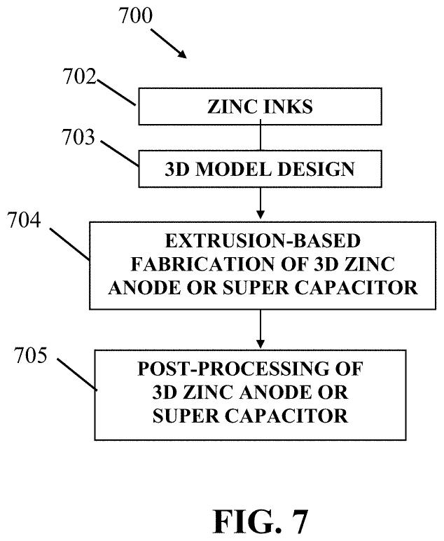

FIG. 7 is a flowchart that illustrates another embodiment of the inventor's apparatus, systems, and methods for producing hierarchical zinc structures.

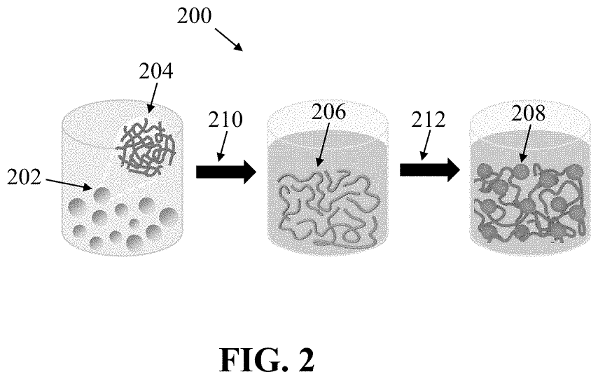

FIG. 2 provides an illustrative flow diagram of the inks development (Reference numeral 200). In an exemplary approach, solid-state copolymer beads 202 with entangled polymeric chains 204 are dissolved into organic solvents 210. The resultant polymer solvation 206 is obtained due to the chains release in solvents. Then, zinc micro-powders 208 are added and thoroughly mixed with the polymer solution 212 to form a uniform colloidal ink.

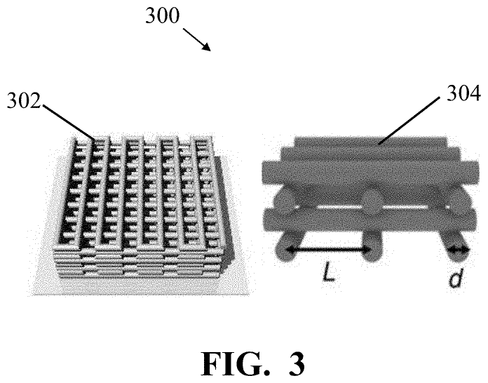

Referring now to FIG. 3, one embodiment of the model of the inventor's microlattice is illustrated. The model is designated generally by the reference numeral 300. The model 300 shown in FIG. 3 illustrates a model for the construction of a square lattice 302 made of the colloidal ink. The model 300 is one embodiment of the model described in the flow charter of FIG. 1 under the heading “Step 2.” The model 300 is designed using computer aided design (CAD) software or other systems for creating a digital model. The model 300 consists of orthogonally stacked parallel filaments array 304 with total of 8 layers. The filament diameter (d) is generally of 200 μm, and center-to-center spacing (L) can be varied from 300-800 μm.

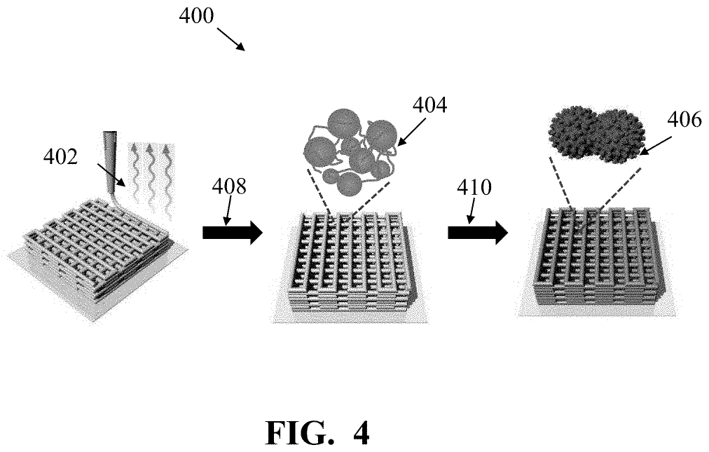

FIG. 4 provides an illustrative flow diagram of the direct ink writing system 400 to make the inventor's zinc microlattice made of colloidal inks. In this example, the DIW operation using the x-y-z motion stage and high precision dispenser forms an extrusion-based, room temperature manufacturing process. The colloidal ink in this example is housed in a 10 ml syringe barrel attached by a Luer-Lok to a smooth-flow tapered nozzle. An air-powered electronically controlled fluid dispenser provides the appropriate pressure to extrude the ink through the nozzle. The target pattern in this example is printed using a mechanical bearing positioning gantry, whose motion is controlled by writing the appropriate G-code commands from the 3D model. The extrusion process may be controlled by controlling the extrusion pressure and printing speed during the writing operation. The organic solvents may evaporate instantaneously 402 after filament deposition leading to a quick fluid-to-solid transition of the ink. The 3D lattice structure is printed in a layer-by-layer scheme onto the alumina plate with hydrophobic coatings. After deposition, the as-printed structure may undergo a slow solvent removal process 408 in the air, and the dissolved copolymers may recover to solid-state and the chains may “glue” zinc particle together to form a green body 404. Finally, the green body will be annealed 410 at higher temperature using optimized heating profile to form the zinc particles fusion and surface morphology improvement 406. This process enables the varying structures to be printed with virtually any 3D shape.

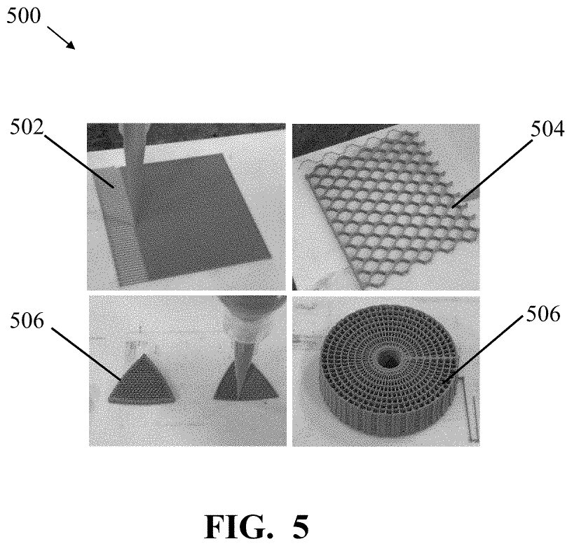

FIG. 5 (500) shows four optical images of real 3D-printed zinc structures of large area lattice 502, high aspect-ratio honeycomb 504, tri-angle lattice 506, and circular lattice 508.

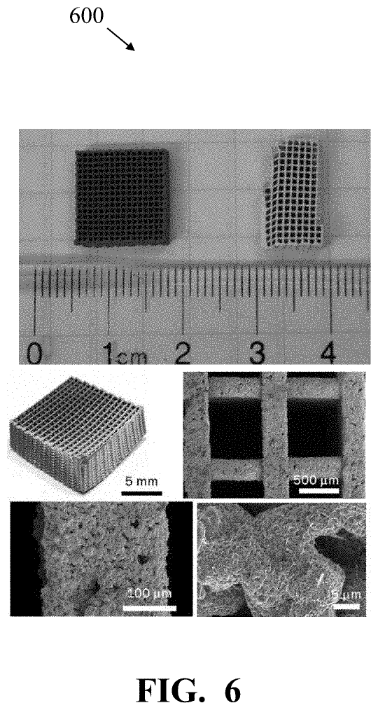

FIG. 6 (600) shows optical and SEM images of the zinc lattice structure and morphology after annealing.

Referring now to FIG. 7, a flow chart illustrates additional embodiments of the inventor's apparatus, systems, and methods for producing 3D zinc structures. The flow charter is designated generally by the reference numeral 700. As illustrated in the flow charter 700, the system includes a number of steps. The steps in FIG. 7 are identified and described below.

Step 1—ZINC INKS DEVELOPMENT (Reference numeral 702)—In step 1, a zinc powder based extrudable ink is developed. This step of providing zinc ink includes providing zinc powders, providing solvents, and providing binders to produce said zinc ink.

Step 2-3D MODEL DESIGN (Reference numeral 703)—In step 2, the 3D geometrical models are designed using computer aided design (CAD) software or other systems for creating a digital model. In one embodiment this step of creating a 3D model of a porous zinc structure includes creating a 3D model of a porous zinc anode. In another embodiment this step of creating a 3D model of a porous zinc structure includes creating a 3D model of a porous zinc current collector for a super capacitor. In yet another embodiment this step of creating a 3D model of a porous zinc structure includes creating a 3D model of a porous zinc current collector for a hybrid super capacitor.

Step 3—EXTRUSION-BASED FABRICATION OF 3D ZINC (Reference numeral 704)—In step 3, the direct ink writing is employed to extrude developed inks into designed structures following the model from Step 2. In one embodiment this step of direct ink writing of a porous zinc structure includes direct ink writing a porous zinc anode. In another embodiment this step of direct ink writing a 3D porous zinc structure includes direct ink writing of a porous zinc current collector for a super capacitor. In yet another embodiment this step of direct ink writing a 3D porous zinc structure includes direct ink writing of a porous zinc current collector for a hybrid super capacitor.

Step 4—POST-PROCESSING OF 3D ZINC STRUCTURES (Reference numeral 705)—In step 4, the as-printed green bodies are processed by drying and annealing to obtain the final products. In one embodiment this step of post processing of a porous zinc structure includes post processing a porous zinc anode. In another embodiment this step of post processing of a porous zinc structure includes post processing a porous zinc super capacitor. In yet another embodiment this step of post processing of a porous zinc structure includes post processing a porous zinc hybrid super capacitor.

Various embodiment described herein may be used for aqueous batteries, for example zinc-manganese oxide batteries. Some embodiments may be used for other energy storage systems, for example zinc-air batteries, flow batteries and zinc-ion hybrid supercapacitors.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A method of 3D printing a porous zinc structure, comprising the steps of:
creating a 3D model of the porous zinc structure,
providing zinc ink,
3D printing said zinc ink into a porous zinc lattice structure using said 3D model, and
post processing said porous zinc lattice structure to produce the porous zinc structure.

2. The method of 3D printing a porous zinc structure of claim 1 wherein said step of creating a 3D model of a porous zinc structure comprises creating a 3D model of a porous zinc structure wherein said porous zinc structure has microarchitectures.

3. The method of 3D printing a porous zinc structure of claim 1 wherein said step of providing zinc ink comprises providing zinc powders, providing solvents, and providing binders to produce said zinc ink.

4. The method of 3D printing a porous zinc structure of claim 1 wherein said step of 3D printing said zinc ink into a porous zinc lattice structure using said 3D model comprises extrusion-based direct-writing 3D printing said zinc ink into a porous zinc lattice structure using said 3D model.

5. The method of 3D printing a porous zinc structure of claim 1 wherein said step of 3D printing said zinc ink into a porous zinc lattice structure using said 3D model comprises 3D printing said zinc ink into a large area porous zinc lattice structure.

6. The method of 3D printing a porous zinc structure of claim 1 wherein said step of 3D printing said zinc ink into a porous zinc lattice structure using said 3D model comprises extrusion-based direct-writing 3D printing said zinc ink into a free-standing 3D porous zinc lattice structure using said 3D model.

7. The method of 3D printing porous zinc structure of claim 1 wherein said step of post processing said porous zinc lattice structure comprises heat treatment of said porous zinc lattice structure.

8. The method of 3D printing porous zinc structure of claim 1
wherein said step of creating a 3D model comprises creating a 3D model of an anode for a zinc battery,
wherein said step of 3D printing said zinc ink into a porous zinc lattice structure using said 3D model comprises 3D printing said zinc ink into a porous zinc lattice structure of an anode for a zinc battery using said 3D model of an anode for a zinc battery, and
wherein said step of post processing said porous zinc lattice structure to produce the porous zinc structure comprises post processing said porous zinc lattice structure of an anode for a zinc battery to produce an anode for a zinc battery.

9. The method of 3D printing porous zinc structure of claim 1
wherein said step of creating a 3D model comprises creating a 3D model of a current collector for a supercapacitor,
wherein said step of 3D printing said zinc ink into a porous zinc lattice structure using said 3D model comprises 3D printing said zinc ink into a porous zinc lattice structure of a current collector for a supercapacitor, and
wherein said step of post processing said porous zinc lattice structure to produce the porous zinc structure comprises post processing said porous zinc lattice structure of a current collector for a supercapacitor to produce the porous zinc structure.

10. A method of 3D printing a porous zinc anode, comprising the steps of:
creating a 3D model of the porous zinc anode,
providing zinc ink,
3D printing said zinc ink into a porous zinc lattice anode using said 3D model, and
post processing said porous zinc lattice anode to produce the porous zinc anode.

11. The method of 3D printing a porous zinc anode of claim 10 wherein said step of creating a 3D model of a porous zinc anode comprises creating a 3D model of a porous zinc anode wherein said porous zinc anode has microarchitectures.

12. The method of 3D printing a porous zinc anode of claim 10 wherein said step of providing zinc ink comprises providing zinc powders, providing solvents, and providing binders to produce said zinc ink.

13. The method of 3D printing a porous zinc anode of claim 10 wherein said step of 3D printing said zinc ink into a porous zinc lattice anode using said 3D model comprises extrusion-based direct-writing 3D printing said zinc ink into a porous zinc lattice anode using said 3D model.

14. The method of 3D printing a porous zinc anode of claim 10 wherein said step of 3D printing said zinc ink into a porous zinc lattice anode using said 3D model comprises 3D printing said zinc ink into a large area porous zinc lattice anode.

15. The method of 3D printing a porous zinc anode of claim 10 wherein said step of 3D printing said zinc ink into a porous zinc lattice anode using said 3D model comprises extrusion-based direct-writing 3D printing said zinc ink into a free-standing 3D porous zinc lattice anode using said 3D model.

16. The method of 3D printing porous zinc anodes of claim 10 wherein said step of post processing said porous zinc lattice anode comprises heat treatment of said porous zinc lattice anode.

17. An apparatus for making a porous zinc structure, comprising:
means for producing zinc ink,
means for creating a 3D model of a porous zinc structure,
means for 3D printing said zinc ink into a porous zinc lattice structure using said 3D model, and
means for post processing said porous zinc lattice structure to produce the porous zinc structure.

18. The apparatus for making a porous zinc structure of claim 17 wherein said means for producing zinc ink comprises means for providing zinc powders, providing solvents, and providing binders to produce said zinc ink.

19. The apparatus for making a porous zinc structure of claim 17
wherein said means for creating a 3D model of a porous zinc structure comprises means creating a 3D model of a porous zinc structure anode for a zinc battery,
wherein said means for 3D printing said zinc ink into a porous zinc lattice structure using said 3D model comprises means for 3D printing said zinc ink into a porous zinc lattice structure of an anode for a zinc battery using said 3D model of an anode for a zinc battery, and
wherein said means for post processing said porous zinc lattice structure to produce the porous zinc structure comprises means for post processing said porous zinc lattice structure to produce the porous zinc structure of an anode for a zinc battery to produce an anode for a zinc battery.

20. The apparatus for making a porous zinc structure of claim 17
wherein said means for creating a 3D model of a porous zinc structure comprises means creating a 3D model of a porous zinc structure current collector for a supercapacitor,
wherein said means for 3D printing said zinc ink into a porous zinc lattice structure using said 3D model comprises means for 3D printing said zinc ink into a porous zinc lattice structure of a supercapacitor using said 3D model of a current collector for a supercapacitor, and
wherein said means for post processing said porous zinc lattice structure to produce the porous zinc structure comprises means for post processing said porous zinc lattice structure to produce the porous zinc structure of a current collector for a supercapacitor.
